(19) United States
(12) Patent Application Publication
(10) Pub. No.: US 2013/0222230 A1
(43) Pub. Date: Aug. 29, 2013

(54) MOBILE DEVICE AND METHOD FOR RECOGNIZING EXTERNAL INPUT

(71) Applicant: Pantech Co., Ltd., (US)

(72) Inventors: In Ho CHOI, Seoul (KR); Ki Cheol KIM, Gimpo (KR); Ji Yeon KIM, Seoul (KR)

(73) Assignee: PANTECH CO., LTD., Seoul (KR)

(21) Appl. No.: 13/681,736

(22) Filed: Nov. 20, 2012

(30) Foreign Application Priority Data
Feb. 29, 2012 (KR) 10-2012-0021498

(51) Int. Cl. G06F 3/16

(52) U.S. Cl. CPC G06F 3/167
USPC 345/156

(57) ABSTRACT

A. mobile device includes a plurality of microphones to recognize a sound generated from an external input, a sensor to recognize an impulse generated from the external input, and a processor. The processor determines multiple regions around the mobile device, determines whether the external input is generated in a region among the multiple regions based on the recognized sound and the impulse, and executes an instruction corresponding to the region. A method that uses a processor to recognize an external input includes recognizing a sound generated from an external input, recognizing an impulse generated from the external input, determining, using the processor, a location of the external input around a mobile device based on the recognized sound and the impulse, and executing an instruction corresponding to the location of the external input.

### CROSS-REFERENCE TO RELATED APPLICATION

This application claims priority from and the benefit under 35 U.S.C. §119(a) of Korean Patent Application No. 10-2012-0021498, filed on Feb. 29, 2012, which is incorporated herein by reference for all purposes as if fully set forth herein.

### BACKGROUND

1. Field

The following description relates to a mobile device and method for detecting a location of an external input.

2. Discussion of the Background

A time difference between a reference signal, such as an infrared signal and a radio frequency signal, and an ultrasonic signal may be used to recognize an input for a device without using a touch screen, a touch panel, or a tablet PC. That is, a signal generating device for generating a reference signal and ultrasonic signal may be installed to an input pen so as to measure an absolute location of the input pen with respect to the device.

However, according to the input method or location measuring method utilizing the input pen generating the reference signal or the ultrasonic signal, various receiving sensors capable of recognizing the infrared signal, radio frequency signal, and ultrasonic signal need to be installed on the mobile device.

For example, in order to measure a location using an ultrasonic sensor, a plurality of ultrasonic sensors may need to be connected to the mobile device, or need to be installed in the mobile device while the mobile device is manufactured.

However, according to the methods described above, an ultrasonic sensor or ultrasonic sensor-installed frame may be an inconvenience to carry the ultrasonic sensor or ultrasonic sensor-installed frame, or it may be difficult to manufacture smaller mobile devices including a plurality of ultrasonic sensors.

### SUMMARY

Exemplary embodiments of the present invention provide a mobile device and method for recognizing an external input based on a sound and an impulse generated in proximity to the mobile device.

Additional features of the invention will be set forth in part in the description which follows and, in part, will be apparent from the description, or may be learned by practice of the invention.

Exemplary embodiments of the present invention provide a. mobile device including a plurality of microphones to recognize a sound generated from an external input, a sensor to recognize an impulse generated from the external input, and a processor. The processor determines multiple regions around the mobile device, determines whether the external input is generated in a region among the multiple regions based on the recognized sound and the impulse, and executes an instruction corresponding to the region.

Exemplary embodiments of the present invention provide a method that uses a processor to recognize an external input including recognizing a sound generated from an external input, recognizing an impulse generated from the external input, determining, using the processor, a location of the external input around a mobile device based on the recognized sound and the impulse, and executing an instruction corresponding to the location of the external input.

Exemplary embodiments of the present invention provide a mobile device including a plurality of microphones to recognize a sound generated from an external input, a sensor to recognize an impulse generated from the external input, a distance calculation unit to calculate a time difference between a first receiving time from the external input to a first microphone and a second receiving time from the external input to a second microphone based on the recognized sound, a direction calculation unit to calculate a direction of the external input based on the recognized impulse, and a processor. The processor determines a location of the external input based on the time difference and the direction, and executes an instruction corresponding to the location of the external input.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a mobile device capable of detecting a location of a sound source according to an exemplary embodiment of the present invention.

FIG. 2 is a flowchart illustrating a control method of a mobile device capable of detecting a location of a sound source according to an exemplary embodiment of the present invention.

FIG. 3A is a diagram illustrating a mobile device including dual microphone according to an exemplary embodiment of the present invention, and FIG. 3B is a diagram illustrating a magnitude of a signal inputted to dual microphone of a mobile device according to an exemplary embodiment of the present invention.

FIG. 4A is a diagram illustrating a mobile device including dual microphone according to an exemplary embodiment of the present invention, and FIG. 4B and FIG. 4C are graphs illustrating a receiving time difference between signals inputted to dual microphone.

FIG. 5A is a diagram illustrating a mobile device including a gyro sensor according to an exemplary embodiment of the present invention, FIG. 5B is a diagram illustrating a displacement of a mobile device according to an exemplary embodiment of the present invention, and FIG. 5C is a diagram illustrating a magnitude of a signal inputted to a gyroscope sensor according to an exemplary embodiment of the present invention.

FIG. 6A is a diagram illustrating a mobile device to sense sequential inputs according to an exemplary embodiments of the present invention, FIG. 6B is a graph illustrating a magnitude of a signal inputted to dual microphone according to an exemplary embodiments of the present invention, and FIG. 6C is a diagram illustrating a magnitude of a signal inputted to a gyroscope sensor according to an exemplary embodiments of the present invention.

FIG. 7 illustrates an estimated range of a location of a signal inputted to dual microphone and an estimated range of the location of the signal inputted to a gyroscope sensor according to an exemplary embodiment of the present invention.

FIG. 8 is a diagram for describing coordinates of a direction sensor for communication between mobile devices according to an exemplary embodiment of the present invention.

FIG. 9A and FIG. 9B are diagrams illustrating a location estimating method for communication between mobile devices according to an exemplary embodiment of the present invention.

FIG. 10A, FIG. 10B, FIG. 10C, FIG. 10D, and FIG. 10E are diagrams illustrating a location estimating method for a communication between mobile devices according to an exemplary embodiment of the present invention;

FIG. 11A, FIG. 11B, and FIG. 11C are diagrams illustrating a pattern unlock method according to an exemplary embodiment of the present invention.

FIG. 12A and FIG. 12B are diagrams illustrating a method for unlocking a locked state of a mobile device according to an exemplary embodiment of the present invention.

FIG. 13 is a diagram illustrating a call receiving/rejecting method according to an exemplary embodiment of the present invention.

FIG. 14 is a diagram illustrating a method for recognizing a browser gesture according to an exemplary embodiment of the present invention.

FIG. 15A and FIG. 15B are diagrams illustrating a mole game method according to an exemplary embodiment of the present invention.

FIG. 16 illustrates a distance measuring method according to an exemplary embodiment of the present invention.

FIG. 17A, FIG. 17B, and FIG. 17C are diagrams illustrating a Braille input method according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

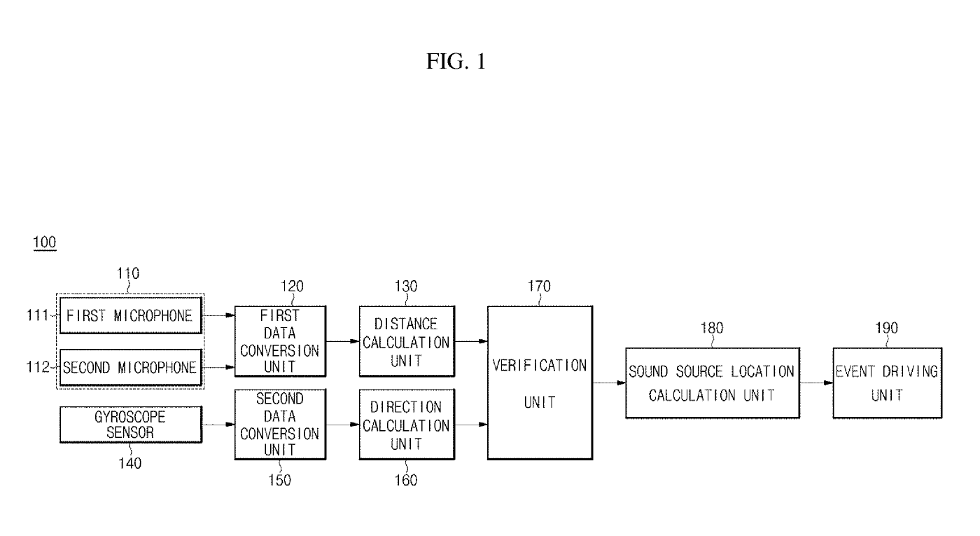

FIG. 1 is a block diagram illustrating a mobile device capable of detecting a location of a sound source according to an exemplary embodiment of the present invention.

As illustrated in FIG. 1, a mobile device 100 includes dual microphone 110, a first data conversion unit 120, a distance calculation unit 130, a gyroscope sensor 140, a second data conversion unit 150, a direction calculation unit 160, a verification unit 170, and a sound source location calculation unit 180. The mobile device 100 may further include an event driving unit 190. The distance calculation unit 130, the direction calculation unit 160, the verification unit 170, and the sound source location calculation unit 180, and the event driving unit 190 may be implemented as software modules and be stored in a storage unit (not shown) and one or more processor (not shown) may execute a portion of or all the operations of the distance calculation unit 130, the direction calculation unit 160, the verification unit 170, and the sound source location calculation unit 180, and the event driving unit 190.

A mobile device may refer to a device that may provide a video communication, an audio communication, and an internet search, and a mobile device typically includes a display having a touch screen or a small keyboard. The mobile device may be one selected from a smartphone, an ultra mobile personal computer (UMPC), a personal digital assistant (PDA), and the like, and may provide various functions in addition to the communication function.

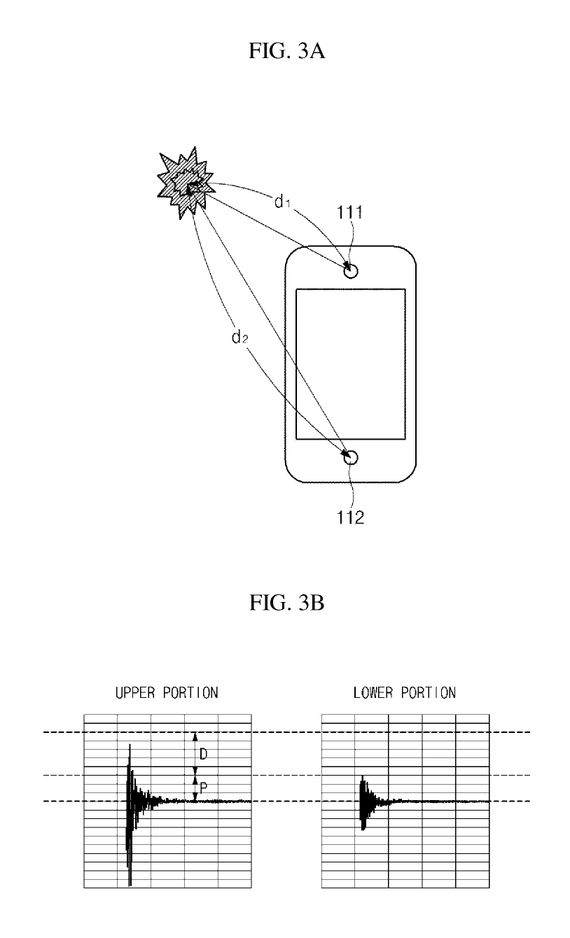

The dual microphone 110 may include a first microphone 111 and a second microphone 112. The first microphone 111 and the second microphone 112 may be respectively installed on upper and lower portions or left and right portions of the mobile device 100. As shown in FIG. 3a, in order to increase the distance between the first microphone 111 and the second microphone 112, the first microphone 111 and the second microphone 112 may be arranged on an upper portion and a lower portion, respectively. Further, more than two microphones may be arranged in a mobile device. A multi-microphone array may refer to multiple microphones arranged in a mobile device 100, and the multiple microphones may be arranged with a distance between each other. The first and second microphones 111 and 112 are separated from each other by a certain distance, and sense sounds generated from an origin of the sounds (hereinafter, the origin of the sounds may be referred to as a sound source) to transmit the sensed sounds to the first data conversion unit 120. Further, as the sample rate of the dual microphone 110 increases, a distance to the sound source is more accurately sensed.

The first and second microphones 111 and 112 may calculate points having a certain distance difference between distance d1 and distance d2 as shown in FIG. 3a based on a receiving time difference of a particular waveform (having a certain frequency), and may calculate a distance from the mobile device 100 to the sound source by using the distance difference. Since the first and second microphones 111 and 112 are separated from each other by a certain distance, there may be a receiving time difference of a sound wave propagated from a sound source if the sound wave is received by the first microphone 111 and the second microphone 112, respectively. If the first microphone 111 is closer to the sound source than the second microphone 112, the first microphone 111 senses the sound generated from the sound source earlier than the second microphone 112, and then the second microphone 112 senses the sound. Therefore, by using this phenomenon, the distance from the mobile device to the sound source may be calculated.

The first data conversion unit 120 may convert analog data sensed by the dual microphone 110 into Pulse-Code Modulation (PCM) digital data, and outputs the PCM digital data to the distance calculation unit 130. The analog data obtained from the first and second microphones 111 and 112 have a time difference therebetween as described above.

The distance calculation unit 130 may calculate a time difference value between sections of the same waveform (same signal) from the PCM digital data, and then derives a distance difference value between distances from the first and second microphones 111 and 112 to the sound source, respectively, by using the time difference value and the speed of the sound wave. The distance difference value may be obtained as a solution of a multivariate quadratic equation (a set of points having the same distance difference), and thus, the distance difference value is obtained as a hyperbolic form. A more detailed method for calculating the distances from the first and second microphones 111 and 112 to the sound source will be described later. Further, the distance difference value may be transmitted to the verification unit 170.

The gyroscope sensor 140 may be installed in the mobile device, and may sense an impulse or vibration generated from the sound source to transmit the sensed impulse or vibration to the second data conversion unit 150. The orientation of the mobile device 100 may be changed by the impulse generated from the external sound source. The gyroscope sensor 140 senses an angular velocity and displacement data of the mobile device 100 and transmits the sensed angular velocity and the displacement to the second data conversion unit 150. The gyroscope sensor 140 may be capable of not only determining up, down, left, and right directions but also comparing magnitudes of gradients and measuring angular velocities with respect to three axes for three dimensions at an angle of 360 degrees.

The second data conversion unit 150 may convert angular velocities for respective axes (X, Y, and Z) obtained from the gyroscope sensor 140 into angular velocity data, and may output the angular velocity data to the direction calculation unit 160. The second data conversion unit 150 may obtain angular velocity data for one axis (X-axis, Y-axis, or Z-axis) for calculation.

The direction calculation unit 160 may calculate a vector value on a two-dimensional (X and Y) plane based on the angular velocity data. Since a vector is a physical quantity having a magnitude and a direction, the vector value may be obtained by the direction calculation unit 160 as a solution of a linear equation using a magnitude and a gradient (direction) from X-axis. The direction value may be obtained as a linear form. A method for deriving the direction value will be described in more detail later. The direction value may be transmitted to the verification unit 170.

The verification unit 170 may verify whether the data respectively obtained from the dual microphone 110 and gyroscope sensor 140 are valid data. For instance, if there is a sensed value of the gyroscope sensor 140 without a sensed value of the dual microphone 110, or there is the sense value of the dual microphone 110 without the sensed value of the gyroscope sensor 140, or there is no sensed value, the sound location calculation unit 180 may not be operated. The verification unit 170 may control the sound source location calculation unit 180 to operate if there are the sensed value of the dual microphone 110 and the sensed value of the gyroscope sensor 140.

The sound source location calculation unit 180 may receive sensed data respectively from the distance calculation unit 130 and direction calculation unit 160, and may calculate the location of the sound source located at the outside of the mobile device 100 by using the sensed data. The location of the sound source may be calculated based on the solution of the multivariate quadratic equation, i.e., the hyperbola, obtained by using the dual microphone 110 and the solution of the linear equation, i.e., the straight line, obtained by using the gyroscope sensor 140. The sound source location calculation unit 180 may determine a point of intersection, where the hyperbola and the straight line intersect, as the location of the sound source.

The event driving unit 190 may obtain virtualized coordinates around the mobile device to divide the coordinates into multiple blocks (or “regions”), and may control an execution of an event corresponding to a particular block if it is determined that the sound source located in the particular block. Thus, the mobile device 100 may be controlled based on an external input without touching the mobile device 100. The external input may include a sound signal and an impulse signal (or a vibration signal). The sound signal may be sensed a microphone and the impulse signal (or the vibration signal) may be sensed by a gyroscope sensor. For instance, the event driving unit 190 may execute one event among location tracing for communication, pattern unlock, releasing of a locked state, receiving a call, rejecting a call, browser gesture, game, and distance measurement, and the like, based on a determination of the location of the external input. Throughout the specification, the external input that may generate a sound may be referred to as the sound source.

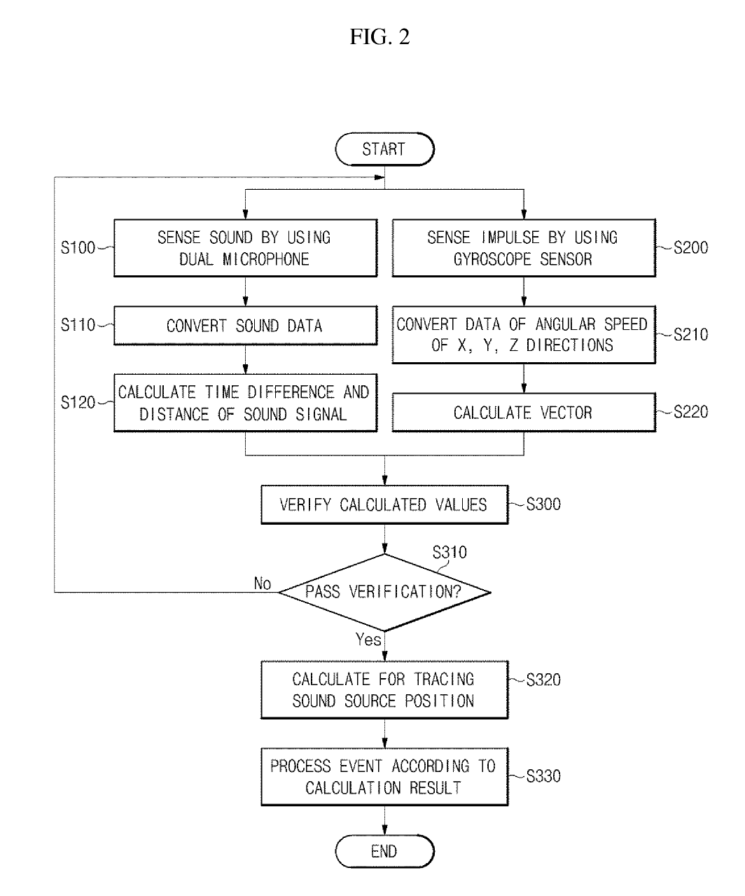

FIG. 2 is a flowchart illustrating a control method of a mobile device capable of detecting a location of a sound source according to an embodiment of the present invention. FIG. 2 will be described as if performed by mobile device 100 shown in FIG. 1, but is not limited as such. As illustrated in FIG. 2, a method for controlling the mobile device capable of detecting the location of the sound source includes a sound sensing operation S100, a sound data converting operation S110, a sound signal time difference and distance difference calculating operation S120, an impulse sensing operation S200, an angular velocity data converting operation S210, an operation for calculating a vector having a magnitude and direction S220, a calculated value verifying operation S300, a verification result determining operation S310, and a calculating operation for tracing the location of the sound source S320. The present invention may further include an event processing operation S330.

In operation S100, a sound generated from the sound source or an impact or vibration point is sensed by using the dual microphone 110 of the mobile device 100. The sound generated from the external sound source may be sensed by using the first and second microphones 111 and 112 installed on the upper and lower portions of the mobile device 100.

In operation S110, the analog sound data may be converted into PCM digital data by the first data conversion unit 120.

In operation S120, a receiving time difference and a distance difference with respect to a sound signal from the external sound source by using the distance calculation unit 130 installed to the mobile device 100. The distance calculation unit 130 may calculate candidates of the location of the sound source as a hyperbolic trace that is the solution of the multivariate quadratic equation, or transmit related data so that the sound source location calculation unit 180 may perform the calculation of the candidates of the location of the sound source.

In operation S200, the impulse (vibration) generated from the sound source may be sensed by using the gyroscope sensor 140 installed to the mobile device 100. The angular velocities and displacement of the mobile device 100 caused by the impulse of the external sound source may be sensed by using the gyroscope sensor 140.

In operation S210, values obtained from the gyroscope sensor 140 may be converted into the angular velocity (digital) data of the mobile device 100 by using the second data conversion unit 150 installed to the mobile device 100.

In operation S220, the vector value on the two-dimensional plane may be calculated based on the angular velocity value by using the direction calculation unit 160 installed to the mobile device 100. The direction calculation unit 160 may calculate candidates of the location of the external sound source as the linear trace that is the solution of the linear equation, or transmit related data so that the sound source location calculation unit 180 may perform the calculation of the candidates of the location of the external sound source.

In operation S300, the verification unit 170 of the mobile device 100 may verify whether the both the distance difference value and vector value exist.

In operation S310, it is determined, by using the verification unit 170 of the mobile device, whether the distance difference value and direction vector value are valid values to be used for calculation. For example, if the distance difference value and vector value are smaller than reference values, the calculation may not be performed.

In operation S320, the sound source location calculation unit 180 may calculate the location of the sound source based on the hyperbolic trace and the linear trace. Specifically, the intersection point between the solution of the multivariate quadratic equation, i.e., the hyperbolic trace, obtained by using the dual microphone 110 and the solution of the linear equation, i.e., the linear trace, obtained by using the gyroscope sensor 140 may be determined as the location of the sound source.

In operation S330, the event driving unit 190 installed to the mobile device 100 may process an event corresponding to a calculated location of a sound source. If a particular region around the mobile device 100 is determined to include the location of the sound source, a particular event that corresponds to the particular region is processed. As described above, the event may be one among an event for location tracing for communication, an event for pattern unlock, an event for releasing of a locked state, an event for receiving a call, an event for rejecting a call, an event for browser gesture, an event for selecting a game, and an event for distance measurement, and the like. Further, an application may be controlled by an external input and different operations may be performed based on a determination of the location of the external input. For example, an application may perform a first operation if it is determined that the location of the external input belongs to a first region among multiple regions, and may perform a second operation if it is determined that the location of the external input belongs to a second region among the multiple regions. Further, a user of the mobile device may define an operation or instruction corresponding to a region among multiple regions. For example, a user may define an instruction to play a song using a music player in response to an external input located in a region among multiple regions.

Hereinafter, a method for calculating the location of the external sound source will be described in more detail below.

FIG. 3A is a diagram illustrating a mobile device including dual microphone according to an exemplary embodiment of the present invention, and FIG. 3B is a diagram illustrating a magnitude of a signal inputted to dual microphone of a mobile device according to an exemplary embodiment of the present invention. As illustrated in FIG. 3A, the dual microphone, the first and second microphones 111 and 112, may be respectively installed on the upper and lower portions of the mobile device. As shown in FIG. 3A, it may be assumed that the mobile device is horizontally disposed on a table.

In this state, if a sound wave is generated by a sound source in an upper-left direction of the mobile device, for instance, if an upper left portion of the table from the mobile device is touched when the mobile device is placed on the table, data illustrated in FIG. 3B may be obtained by the dual microphone by sensing the sound wave. In the graphs shown in FIG. 3B, the X-axis denotes time and the Y-axis denotes intensity of the sound, impact, or vibration.

As illustrated in FIG. 3B, the intensity of the sound inputted to the first microphone 111 installed on the upper portion of the mobile device is greater than the intensity of the sound inputted to the second microphone 112 installed on the lower portion of the mobile device. Thus, it may be determined that the sound source is located closer to the first microphone 111 than the second microphone 112.

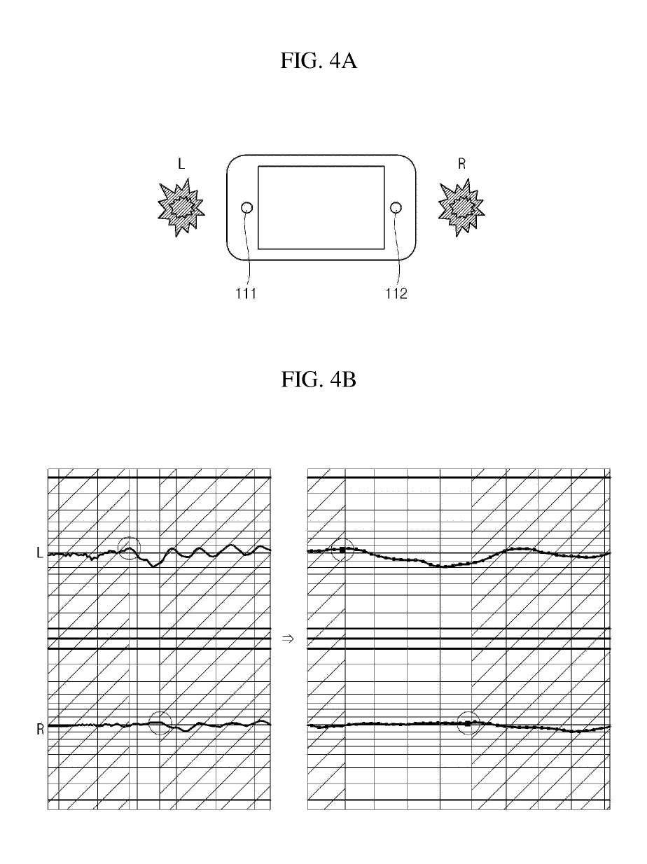

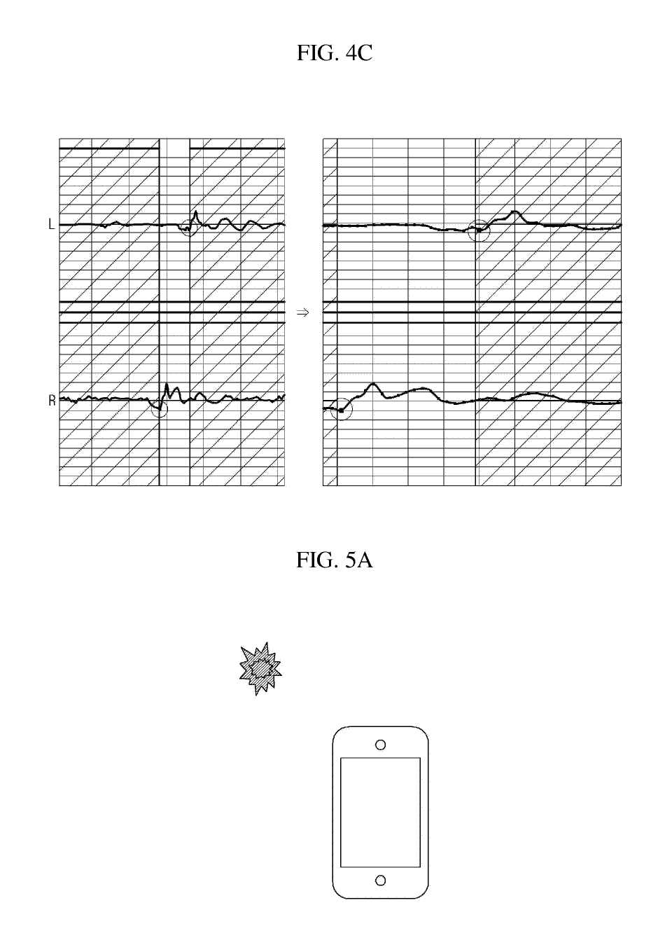

FIG. 4A is a diagram illustrating a mobile device including dual microphones for sensing a sound signal according to an exemplary embodiment of the present invention, and FIG. 4B and FIG. 4C are graphs illustrating a receiving time difference between signals inputted to dual microphone. As illustrated in FIG. 4A, the dual microphone, the first and second microphones 111 and 112, may be respectively installed on the left and right sides of a mobile device. As shown in FIG. 4A, it may be assumed that the mobile device is horizontally disposed on a table. In this state, for instance, if left and right portions L and R of the table with respect to the mobile device are sequentially touched, sensed data illustrated in FIG. 4B and FIG. 4C may be obtained. In the graphs shown in FIG. 4B, the X-axis denotes time and the Y-axis denotes intensity of the sound, impact, or vibration.

If the left portion L is touched, as illustrated in FIG. 4B, the first microphone 111 senses the sound earlier than the second microphone 112.

Further, if the right portion R is touched, as illustrated in FIG. 4C, the second microphone 112 senses the sound earlier than the first microphone 111.

Meanwhile, the distance difference between a first distance from the first microphone 111 to the sound source and a second distance from the second microphone 112 to the sound source may be calculated based on the time difference of receiving the sound between the first microphone 111 and the second microphone 112 and the propagation speed of sound.

The propagation speed of sound in air: V(t)=331.5+(0.61×t)m/s 1)

, where t is a Celsius temperature.

Delay time (time difference)=number of samples×(1/sample rate) 2)

Difference between distances from first and second microphones to sound source=propagation speed of sound×delay time 3)

, where the temperature is about 25° C. and delay time is about 0.0003854 sec, and accordingly, the distance difference is calculated as about 13.36 cm.

In addition, distance difference results according to various sampling rate are shown in Table 1 (reference temperature of 15° C., 340.64 m/s).

TABLE 1

| Sample rate (Hz) | An error range of Distance difference (cm) |
|---|---|
| 11025 | 3.09 |
| 22050 | 1.54 |
| 44100 | 0.77 |
| 48000 | 0.71 |
| 64000 | 0.53 |
| 88200 | 0.39 |

According to Table 1, the error range on the sound source location calculated may have a maximum value of about 3.09 cm if sample rates of microphones are greater than 11,025 Hz. As the sample rate increases, an error range deviating from an actually-measured distance decreases. In order to reduce the error on the sound source location, the sensing sample rates of the first and second microphones may be set higher values without affecting other functions of the mobile device. Furthermore, as the sample rate increases, the external input may be more correctly recognized. Further, the virtualized coordinates surrounding the mobile device may be subdivided into smaller regions if the sample rate increases. Thus, more virtualized regions may be set around the mobile device, and the external input may be more correctly recognized and processed.

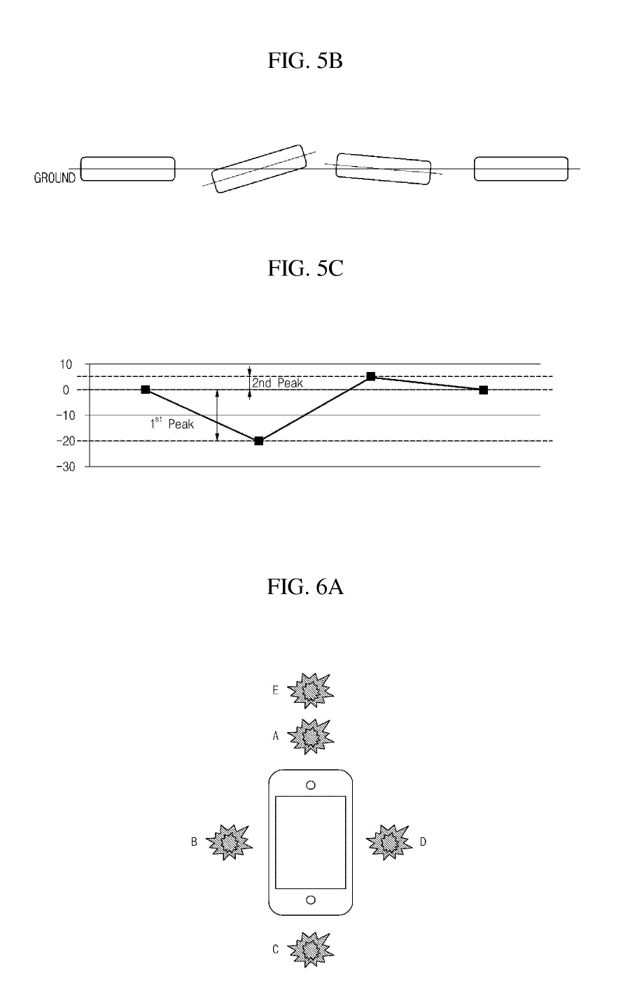

FIG. 5A is a diagram illustrating a mobile device including a gyro sensor for sensing an impulse according to an exemplary embodiment of the present invention, FIG. 5B is a diagram illustrating a displacement of a mobile device according to an exemplary embodiment of the present invention, and FIG. 5C is a diagram illustrating a magnitude of a signal inputted to a gyroscope sensor according to an exemplary embodiment of the present invention. If an upper left portion of a table with respect to a mobile device is touched as illustrated in FIG. 5A, the mobile device vibrates upward and downward on the table (ground) in response to an impulse applied to the mobile device as illustrated in FIG. 5B. According to an impulse sensed by the gyro sensor, sensed data illustrated in FIG. 5C may be obtained. As shown in FIG. 5C, the X-axis denotes time and the Y-axis denotes intensity of the impulse, the sound, vibration, or impact. The sensed data may be obtained by an X-axis gyroscope sensor.

As illustrated in FIG. 5C, since the upper left portion is touched, a negative first peak of the impulse is greater than a positive second peak thereof. Accordingly, it may be determined that the sound source from which a sound wave and an impulse are transmitted is located on the left. If the upper right portion is touched, a positive first peak of the impulse is greater than a negative second peak of the impulse. Accordingly, it may be determined that the sound source is located on the right.

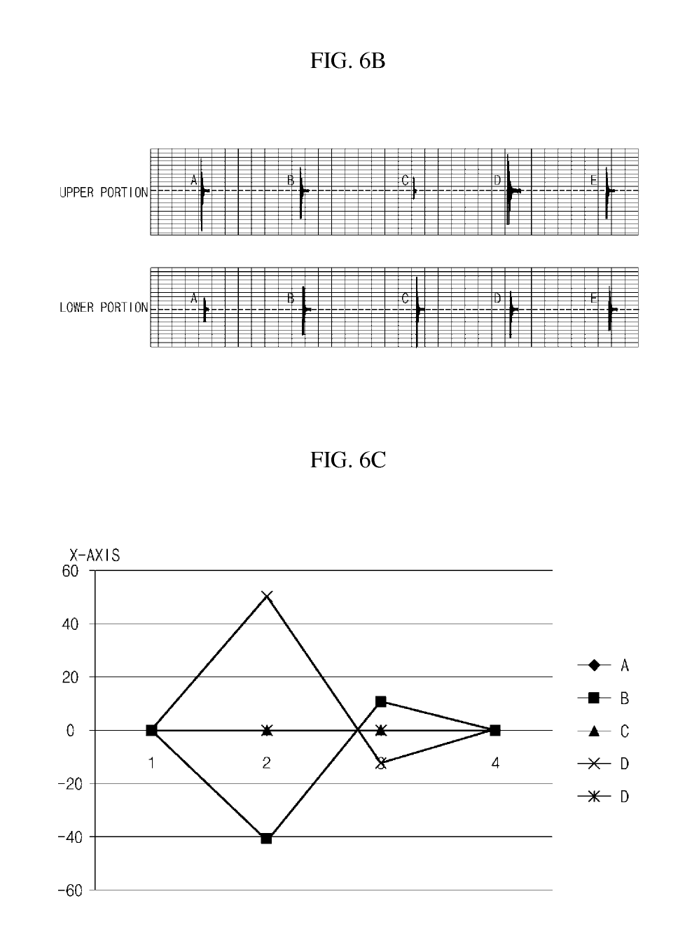

FIG. 6A is a diagram illustrating a mobile device to sense sequential inputs occurred in regions located in proximity to the mobile device according to an exemplary embodiments of the present invention, FIG. 6B is a graph illustrating a magnitude of a signal inputted to dual microphone according to an exemplary embodiments of the present invention, and FIG. 6C is a diagram illustrating a magnitude of a signal inputted to a gyroscope sensor according to an exemplary embodiments of the present invention. As illustrated in FIG. 6A, dual microphone, including a first and second microphones, may be respectively installed on the upper and lower portions of the mobile device. It may be assumed that the mobile device is horizontally disposed on a table as shown in FIG. 6A.

If areas A, B, C, D, and E of the table around the mobile device are impacted as illustrated in FIG. 6A, the first and second microphones respectively sense the impacts as illustrated in FIG. 6B. In the graphs shown in FIG. 6B, the X-axis denotes time and the Y-axis denotes intensity of the sound or impact.

As illustrated in FIG. 6B, when the area A or area E is impacted, the first microphone of the upper portion senses the sound more rapidly that the second microphone of the lower portion. If the area B and area D are impacted, the first and second microphones sense the sounds at substantially the same time. If the area C is impacted, the second microphone of the lower portion senses the sound more rapidly than the first microphone. Based on the time difference in the sensing of the sounds, the location of the sound source may be calculated.

If the area A or area E is impacted, the first microphone of the upper portion senses a relatively louder sound in comparison with the second microphone of the lower portion. If the area B and area D are impacted, the first and second microphones sense sounds having substantially the same loudness level. If the area C is impacted, the second microphone of the lower portion senses a relatively louder sound than the first microphone of the upper portion. Thus, based on the sound loudness difference, candidates of the location of the sound source may also be calculated.

Meanwhile, as illustrated in FIG. 6C, angular velocity of the gyroscope sensor with respect to the X-axis (the axis parallel to the line connecting the first and second microphones) may be sensed in response to an impact occurred around the mobile device, and the gyroscope sensor senses a more intense impact if the area B or area D is impacted.

Further. Table 2 shows values of angular velocity with respect to the X-axis (the axis parallel to the line connecting the first and second microphones) of the gyroscope sensor.

TABLE 2

| | A | B | C | D | E |
|---|---|---|---|---|---|
| 1 | 0.3 | 0.3 | 0.3 | 0.3 | 0.3 |
| 2 | 0 | −40.8 | 0.1 | 50.4 | 0 |
| 3 | 0.2 | 10.5 | 0.2 | −12.4 | 0.1 |
| 4 | −0.1 | 0 | 0 | 0.1 | 0 |

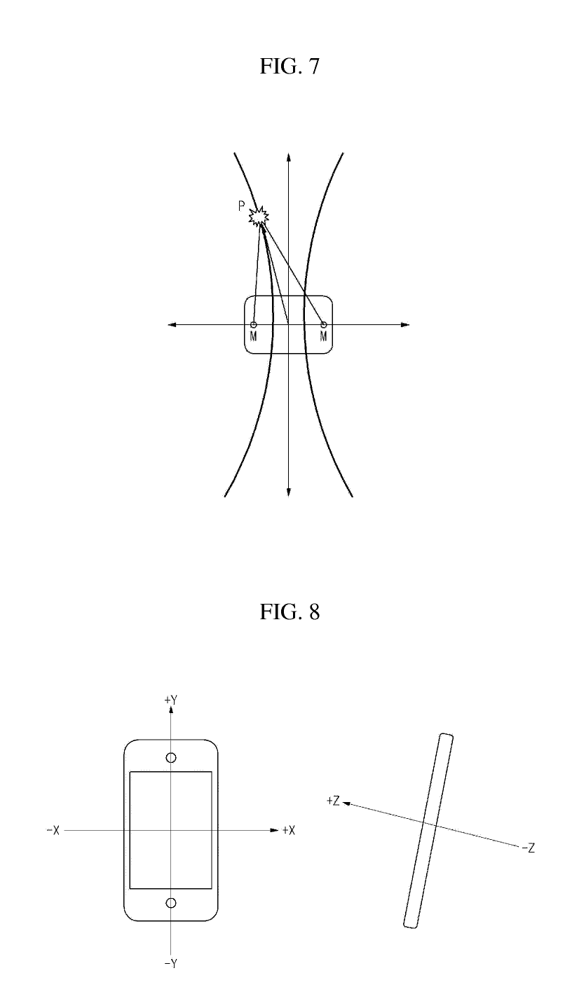

FIG. 7 illustrates an estimated range of data inputted to the dual microphone and an estimated range of data inputted to the gyroscope sensor according to an exemplary embodiment of the present invention.

A first microphone and a second microphone may be respectively installed on the left and right portions of the mobile device. Further, it is assumed that the mobile device is horizontally disposed on a table.

If the upper left portion of the table from the mobile device is touched, a sound wave occurs from a sound source corresponding to the touched area. An estimated distance to the sound source may be obtained as the hyperbolic trace that is the solution of the multivariate quadratic equation by using the dual microphone. Specifically, locations of the first microphone and the second microphone correspond to two focus points of a hyperbola calculated based on a distance difference, and the hyperbolic equation of the hyperbola may be obtained. The distance difference may be calculated based on the distance difference between a distance from the first microphone to a sound source and a distance from the second microphone to the sound source.

One of the left and right curves of the hyperbola may be removed according to a sign of a distance difference value. For instance, if a distance value between a point P (location of the sound source, vibration, or impact) and the first microphone is 5 and a distance value between the point P and the second microphone is 10, the following Equation 1 may be derived.

Difference of distances from point P to first and second microphones=distance from point P to first microphone−distance from point P to second microphone [Equation 1]

From the Equation 1, 5−10=−5 is calculated. Therefore, since the result of the calculation is negative, the right curve with respect to the Y-axis may be removed, and the left curve is selected.

Further, an estimated direction of the sound source is obtained as a straight arrow having a direction as a linear equation based on a sensed data of the gyroscope sensor.

Next, by calculating the point where the left curve of the hyperbola and the line of the linear equation intersect, the location of and distance to the point P, which corresponds to a calculated location of the sound source, may be obtained.

By recognizing the location of the sound source based on the calculations of the dual microphone and gyroscope sensor of the mobile device, an input operation may be performed to the mobile device without touching the mobile device. For instance, various events, such as tracing for communication, pattern unlock, releasing of a locked state, receiving a call, rejecting a call, browser gesture, game, and distance measurement, and the like, may be performed without touching the mobile device.

Hereinafter, various event operations using the above-described detection method of location of the sound source will be described according to exemplary embodiments of the present invention.

FIG. 8 is a diagram for describing coordinates of a direction sensor for communication between mobile devices according to an exemplary embodiment of the present invention.

, A direction sensor of a mobile device may receive an external input and calculate coordinate values corresponding to i.e., Cartesian coordinates of axes (X, Y, and Z), polar coordinates (r, θ, φ), two dimensional polar coordinates (r, θ), and the like. The mobile device may measure an angle toward a location of the external input by using the direction sensor. If the mobile device is horizontally disposed on a table and is rotated with respect to each axis, following values may be obtained.

values[0]: rotation value with respect to the Z-axis (0<=azimuth<360)

0=north, 90=east, 180=south, 270=west

values[1]: rotation value with respect to the X-axis (−180<=pitch<180)

Value is greater than 0 if the screen of the mobile device faces the +Y-axis direction.

Value is 0 when the device is horizontally disposed on a table with the screen of the mobile device facing upward,

Value is −180 or 180 when the screen is facing downward, −90 when the mobile device rotates −90 degrees clockwise with respect to the X-axis, +90 when the mobile device rotates 90 degrees counter clockwise with respect to the X-axis.

values[2]: rotation value with respect to the Y-axis (−90<=roll<90)

Value is greater than 0 if the screen of the mobile device faces the +X-axis direction.

The gyroscope sensor may detect a relative angular change based on an angular velocity, and the relative angular change corresponds to an angle changed from a current reference point. On the other hand, the direction sensor may detect azimuth. Further, a relative location may be detected by using the gyroscope sensor, and an absolute location may be detected by using the direction sensor such as a magnetometer. The direction sensor may be installed in the mobile device in a hardware form. If a direction sensor is not installed in the mobile device, data obtained from the gyroscope sensor or an acceleration sensor may be combined with data obtained from another referential sensor (e.g., terrestrial magnetism sensor) in replacement of the values obtained from the direction sensor.

Data obtained from the direction sensor or terrestrial magnetism sensor may enhance the measurement of a direction calculated by the gyroscope sensor in a case where, e.g., the mobile device is held by a user for direction indication. If the mobile device is held by a user for the direction indication, the direction indication may be more correctly performed by using data obtained from another sensor in addition to the data obtained from the gyroscope sensor. Based on the dual microphone, the position of the external input may be estimated. Further, an auxiliary sensor, such as the gyroscope sensor, the acceleration sensor, the terrestrial magnetism sensor, the direction sensor, and the like, may be used to enhance the accuracy of the position estimation.

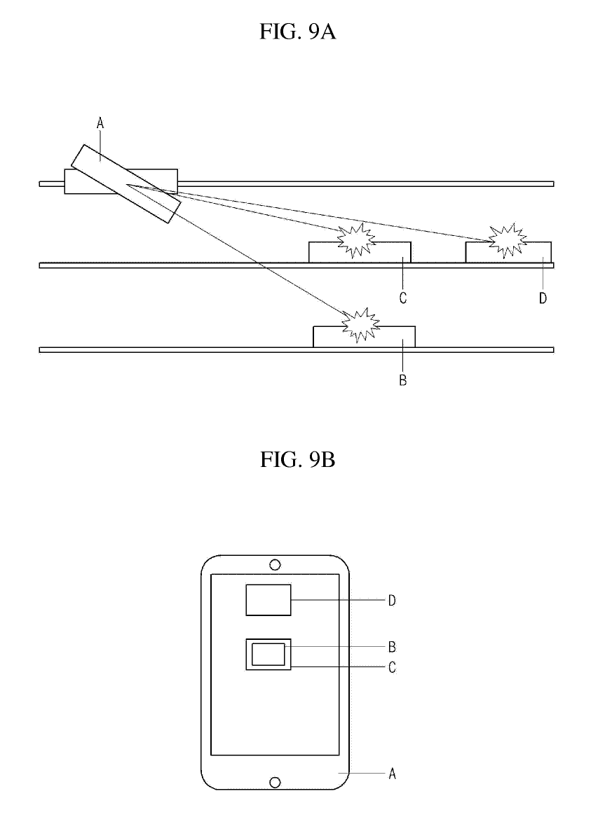

FIG. 9A and FIG. 9B are diagrams illustrating a method for estimating a location of a mobile device according to an exemplary embodiment of the present invention.

By using a direction sensor, locations of nearby mobile devices may be estimated in a two-dimensional space or in a three-dimensional space.

A user of a reference mobile device may indicate a location of a counterpart mobile device, and the counterpart mobile device may generate a sound and the user of the reference mobile device may estimate the location of the counterpart mobile device. For example, mobile devices may sense locations of nearby mobile devices as follows:

(1) Nearby mobile devices B, C, and D generate sound signals.

(2) A user of a reference mobile device A may tilt the reference mobile device A towards the nearby mobile devices B, C, and D.

(3) A direction of the mobile device A is determined by using the direction sensor.

It may be determined that the nearby mobile devices B, C, and D and the reference mobile device A are horizontally arranged in a two-dimensional space to calculate two-dimensional distances.

(4) Heights are calculated based on the distances and angles of the nearby mobile devices B, C, and D.

(5) If a mobile device among the nearby mobile devices B, C, and D displayed on a screen is selected, communication with the selected mobile device may be performed.

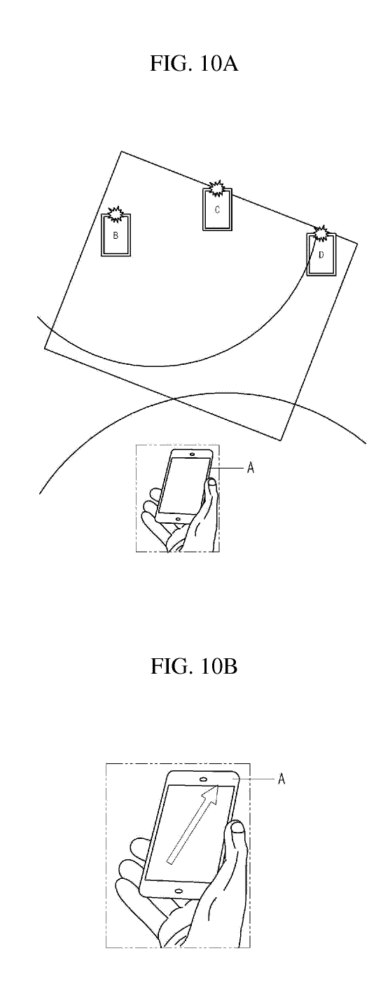

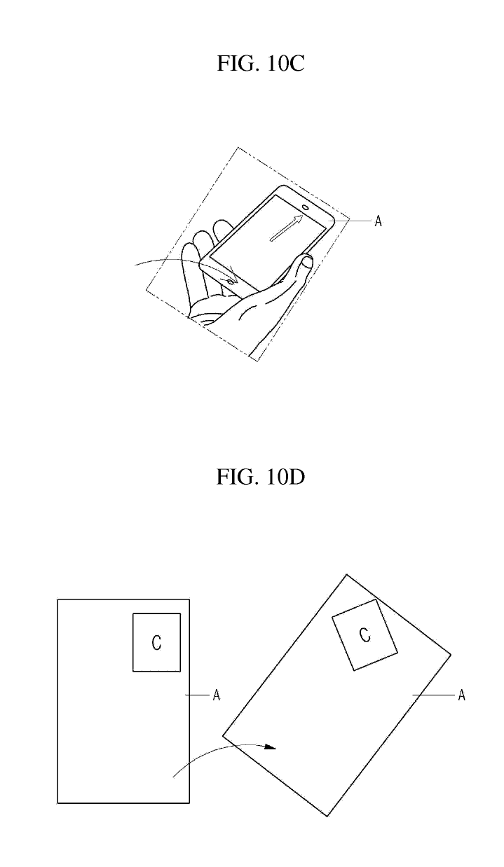

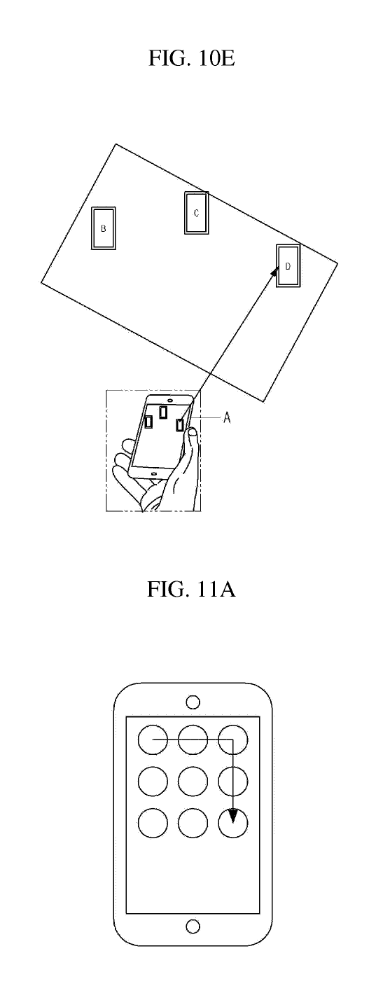

FIG. 10A, FIG. 10B, FIG. 10C, FIG. 10D, and FIG. 10E are diagrams illustrating a location estimating method for a communication between mobile devices according to an exemplary embodiment of the present invention.

If a reference mobile device A recognizes a sound signal of a nearby mobile device D, the estimated range of location for a mobile device generating a sound signal illustrated in FIG. 10A may be obtained.

If the estimated range of location for the mobile device is obtained, the reference mobile device A may indicate one among the nearby mobile devices B, C, and D.

To indicate one nearby mobile device, the user may directly indicate a direction by touching a screen as illustrated in FIG. 10B, or the user may change orientation of the reference mobile device A to indicate one nearby mobile device corresponding to the direction of a reference arrow displayed on the screen as illustrated in FIG. 10C.

In the case of FIG. 10B, since the orientation of the reference mobile device is not changed, the location may be calculated based on the direction received by touching the screen and the estimated candidates in a hyperbola trace.

Further, in the case of FIG. 10C, the location may be calculated based on a movement angle obtained by using the direction sensor of the reference mobile device A.

In this manner, as illustrated in FIG. 10D, a reference coordinate system may be formed on the screen of the reference mobile device A, and the locations of the nearby mobile devices B, C, and D may be calculated in real time to be displayed on the screen as the direction of the reference mobile device A is changed, thereby allowing the user of the reference mobile device A to recognize the locations of the nearby mobile devices B, C, and D.

Further, as illustrated in FIG. 10E, the location of a nearby mobile device to which a file is to be transmitted may be displayed so that the nearby mobile device for receiving the file may be selected and transmitted. Transmission of the file may be performed according to various communication methods including short-range wireless communication methods.

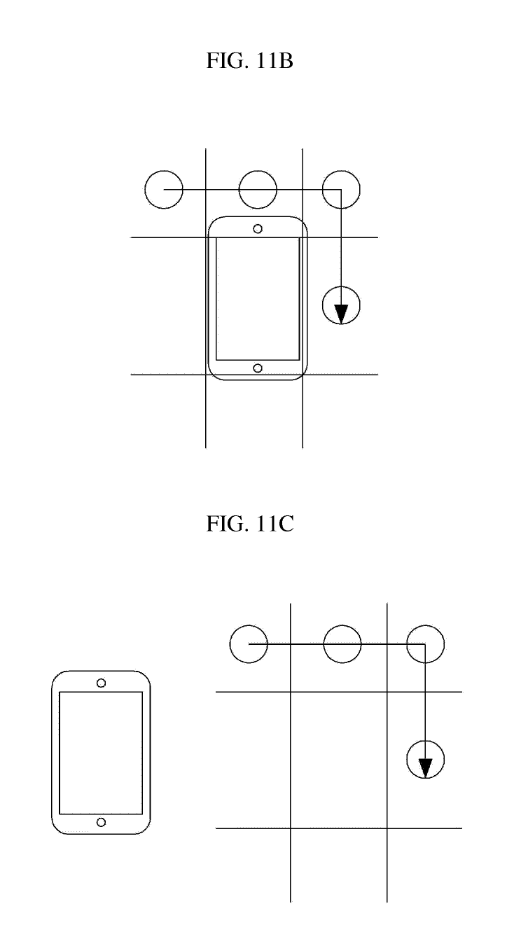

FIG. 11A, FIG. 11B, and FIG. 11C are diagrams illustrating a pattern unlocking method according to an exemplary embodiment of the present invention.

As illustrated in FIG. 11A, the mobile device may be unlocked if a registered unlock pattern input is received as displayed on the screen of the mobile device.

The pattern unlocking operation may be performed by tapping around the mobile device instead of touching the screen by sensing a location of an input generated around the mobile device. For instance, a pattern unlock screen may include nine dots as illustrated in FIG. 11A, and a correct pattern for unlocking the mobile device may be a pattern connecting dots, for example, five dots as shown.

As shown in FIG. 11B, for the pattern unlocking operation, an input on a certain region around the mobile device may correspond to a dot of the pattern unlock screen, and may allow the mobile device to recognize the point as a starting point of the pattern and recognize next input points from the starting point.

As illustrated in FIGS. 11B and 11C, an area surrounding the mobile device may be divided, for example, into four to nine regions and a new pattern may be added by tapping on the divided regions. FIG. 11B illustrates that eight divided regions around the mobile device, and FIG. 11C illustrates nine divided regions located in proximity to the mobile device. Although FIGS. 11B and 11C illustrate 8 and 9 regions, respectively, aspects need not be limited thereto such that the area surrounding the mobile device may be divided into more or fewer regions, for example, 2, 3, 10, 11, 12, etc., regions.

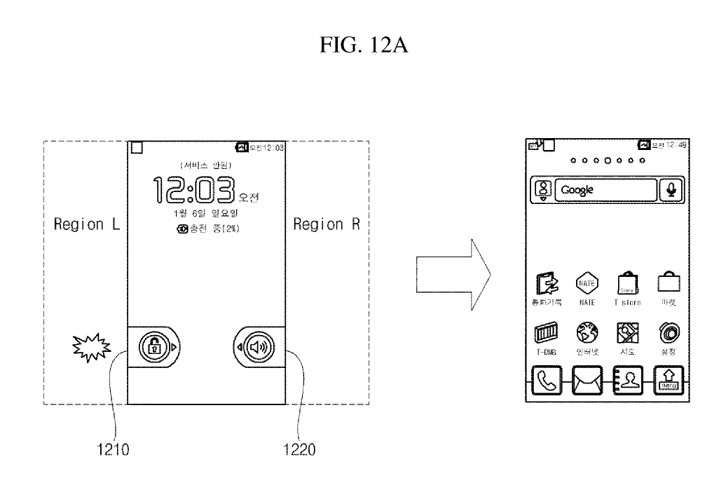

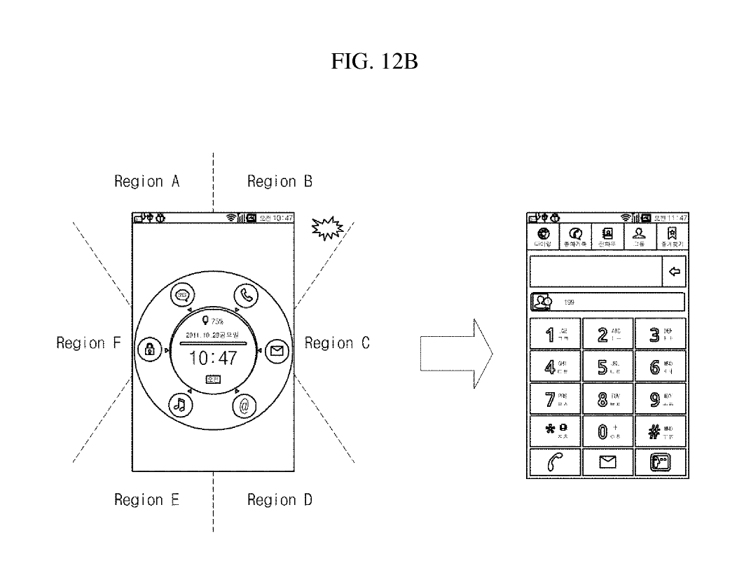

FIG. 12A and FIG. 12B are diagrams illustrating a method for unlocking a locked state of a mobile device according to an exemplary embodiment of the present invention.

As illustrated in FIG. 12A and FIG. 12B, instead of dragging an unlocking icon by directly touching a locked screen of the mobile device, the locked state may be unlocked by tapping on a point located in a corresponding direction to the icon of the locked screen. For example, if the user is not available or not willing to touch the screen (touch panel) of the mobile device to unlock the locked state by using a hand, the user may generate an input signal by generating a sound and an impulse in a corresponding region or tapping on a point of a board located in a corresponding direction, and the direction of the input may be detected by analyzing data of the sound and impact to distinguish an input corresponding to an operation or to perform an operation of an icon corresponding to the direction.

As shown in FIG. 12A, an input is generated in a region L located on the left side of the mobile device to unlock the locked state. An unlocking icon 1210 displayed in a locked screen may correspond to the region L. As shown in FIG. 12B, an input is generated in a region B to perform a function of a call icon and display a call generating screen.

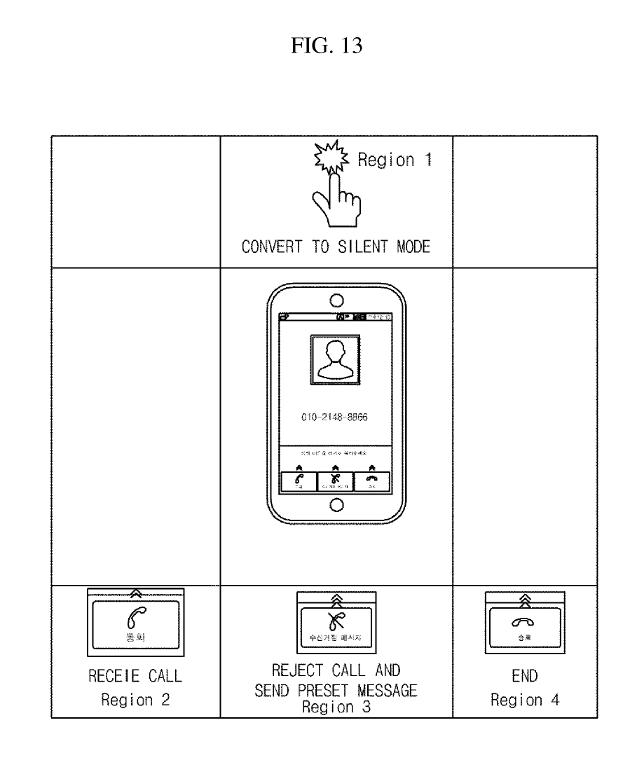

FIG. 13 is a diagram illustrating a call receiving/rejecting method according to an exemplary embodiment of the present invention.

As illustrated in FIG. 13, a space around a mobile device may be divided into four regions, and an event may be executed by generating an input signal in one of the four regions. For instance, an input signal is generated in a region 1, a conversion to a silent mode event may be executed. If an input signal is generated in a region 4, an end event for terminating a call may be executed. If an input signal is generated in a region 3, a call rejection event for rejecting a call and transmitting a call rejecting message may be executed. If an input signal is generated in a region 2, a call receiving event for receiving a call may be executed.

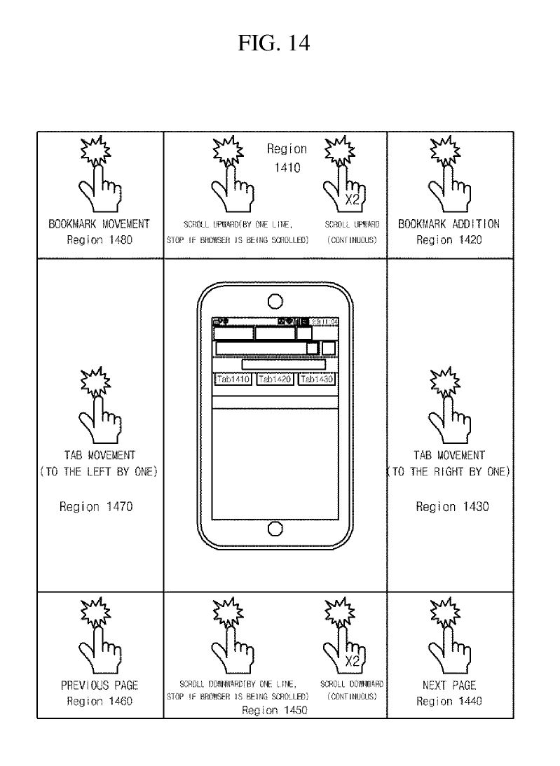

FIG. 14 is a diagram illustrating a method for recognizing a browser gesture according to an exemplary embodiment of the present invention.

As illustrated in FIG. 14, a space around a mobile device may be divided into eight regions, and an event may be executed by generating an input signal in a region corresponding to the event instead of touching a browser screen.

For instance, if an input is generated in a region 1470, a tab movement (to the left by one) event may be performed (e.g., from tab 1420 to tab 1410). If an input is generated in a region 1480, a bookmark movement event may be performed. If an input is generated in a region 1410, an upward scroll (by one line, or stop if the browser is being scrolled) may be performed. If two consecutive inputs are generated in a region 1410, an upward scroll (continuous scrolling) event may be performed. If an input is generated in a region 1420, a bookmark addition event may be performed. If an input is generated in a region 1430, a tab movement (to the right by one) event may be performed (e.g., from tab 1410 to tab 1420). If an input is generated in a region 1440, a next page event for displaying a next page may be performed. If an input is generated in a region 1450, a downward scroll (by one line, or stop if the browser is being scrolled) may be performed. If two consecutive inputs are generated in a region 1450, a downward scroll (continuous scrolling) event may be performed. If an input is generated in a region 1460, a previous page event for displaying a previous page may be performed.

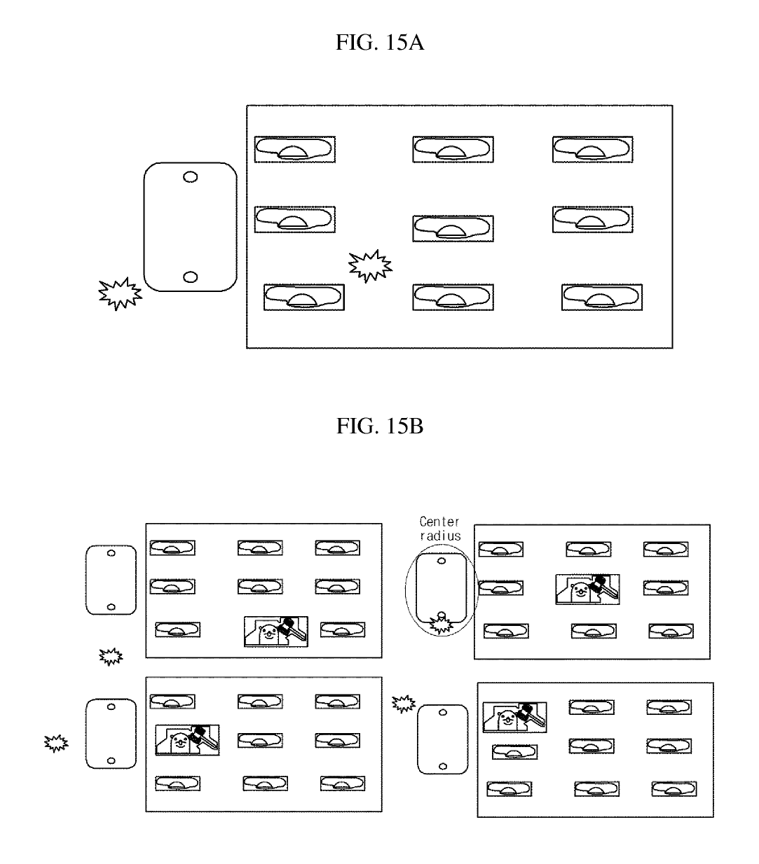

FIG. 15A and FIG. 15B are diagrams illustrating a mole game method according to an exemplary embodiment of the present invention.

Using various sensors installed in a mobile device, information on a location of and distance to an input around the mobile device may be obtained, and various games may be implemented to recognize inputs generated around the mobile device. For example, a mole game may be implemented based on a user input generated around the mobile device.

Multiple regions around a mobile device may be determined and each of the multiple regions may be mapped to an input or a region of a displayed screen image. An input generated in a region may be recognized and a corresponding operation may be performed in an executed game.

The operation may be performed by recognizing the impact of the input and detecting an estimated direction of the input through the gyroscope sensor and by detecting a sound generated by the input through the dual microphone as described above.

As illustrated in FIG. 15A, a game screen may be displayed on a mobile device and each region or coordinate of the game screen may be mapped to a physical region around the mobile device.

As If the game screen is mapped to regions around the mobile device, a mole game may be performed by recognizing an input generated around the mobile device as illustrated in FIG. 15B. For instance, if an input is generated in a point apart from the mobile device in 6 o'clock direction, an event of catching a mole in a hole located on the third row and second column may be executed on the game screen. If an input is generated in a point adjacent to the mobile device, an event of catching a mole in a hole located on the second row and second column may be executed on the game screen. If an input is generated in a point apart from the mobile device in 9 o'clock direction, an event of catching a mole in a hole located on the second row and first column may be executed on the game screen. If an input is generated in a point apart from the mobile device in 11 o'clock direction, an event of catching a mole in a hole located on the first row and first column may be executed on the game screen.

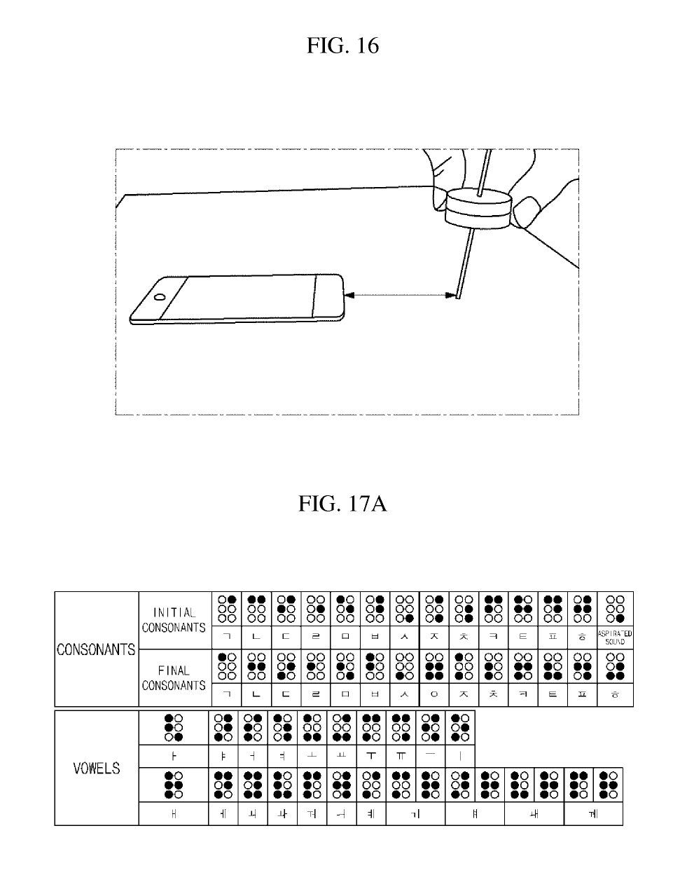

FIG. 16 illustrates a distance measuring method according to an exemplary embodiment of the present invention.

As described above, information on a location of and distance to an input around the mobile device may be obtained using various sensors, and a distance measurement operation may be performed. As shown in FIG. 16, a distance (length) between a mobile device and a point where an input is generated may be measured based on sensed information of various sensors, such as a gyroscope sensor and dual microphone, for example. An application program having a distance (length) measurement function may be installed on the mobile device.

The distance between the mobile device and the point may be measured, quantified, and converted into a sensed data, and may be displayed on a screen of the mobile device.

The distance to the point may be measured by using the dual microphone and gyroscope sensor included in the mobile device. Further, the distance measuring function may be applied to an application program.

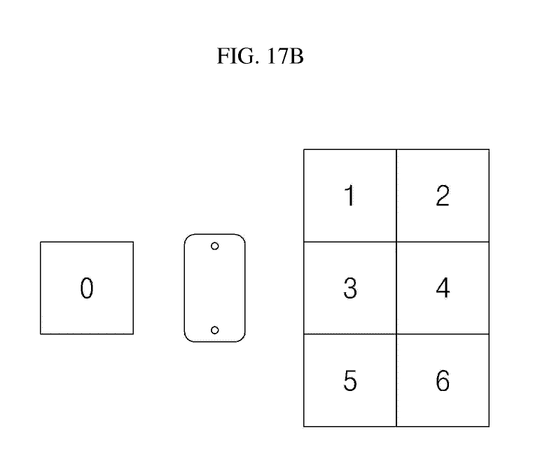

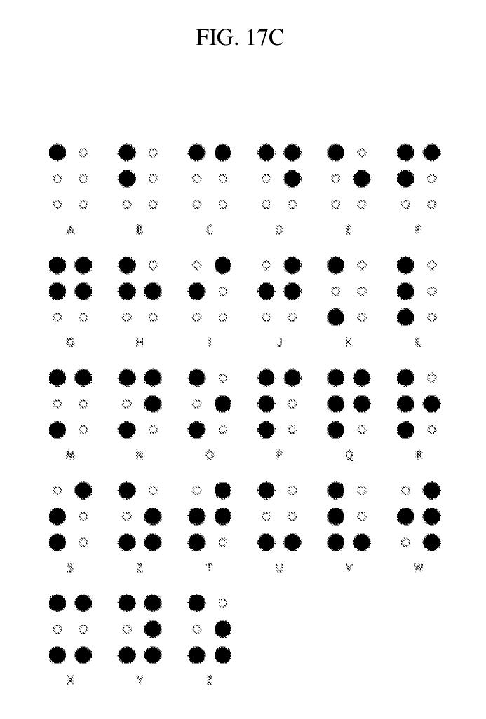

FIG. 17A, FIG. 17B, and FIG. 17C are diagrams illustrating a Braille input method according to an exemplary embodiment of the present invention.

As described above, information on a location of and distance to an input around the mobile device may be obtained based on sensed information of various sensors, the mobile device may provide an input interface to input Braille. Mobile devices equipped with a full touch screen may not provide a physical keyboard, making it difficult for a visually impaired person to input characters using touch screen.

As illustrated in FIG. 17A and FIG. 17C, a combination of six dots constitutes Braille. Based on these characteristics of Braille, as illustrated in FIG. 17B, a location recognizing area of the mobile device may be divided into seven regions 0, 1, 2, . . . , 6 such that a visually impaired person may input Braille by tapping divided regions of a table around the mobile device in the shape of Braille. For instance, the areas 1, 2, 3, 4, 5, and 6 may be used for recognizing a Braille pattern, and the area 0 may be used for notifying completion of input of a single Braille character.

According to an embodiment of the present invention, the location of the external sound source may be recognized by using the dual microphone and gyroscope sensor provided to the mobile device.

Further, according to an embodiment of the present invention, by recognizing the location of the external sound source based on sensed information of the dual microphone and gyroscope sensor provided to the mobile device, the input operation may be performed to the mobile device without touching the mobile device. For instance, according to an embodiment of the present invention, by detecting the location of the sound source in proximity to the mobile device, various events such as tracing for communication, pattern unlock, releasing of a locked state, receiving a call, rejecting a call, browser gesture, game, and distance measurement may be performed without directly touching the mobile device.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile device, comprising:
a plurality of microphones to recognize a sound generated from an external input;
a sensor to recognize an impulse generated from the external input; and
a processor to determine multiple regions around the mobile device, to determine whether the external input is generated in a region among the multiple regions based on the recognized sound and the impulse, and to execute an instruction corresponding to the region.

2. The mobile device of claim 1, wherein the plurality of microphones comprises a first microphone and a second microphone, and the processor calculates a distance difference between a first distance from the external input to the first microphone and a second distance from the external input to the second microphone based on the recognized sound.

3. The mobile device of claim 2, wherein the processor obtains a hyperbola trace based on the distance difference, and calculates candidates of a location of the external input.

4. The mobile device of claim 3, wherein the processor calculates a direction of the external input based on the recognized impulse.

5. The mobile device of claim 4, wherein the processor calculates the location of the external input among the candidates using the direction of the external input.

6. The mobile device of claim 1, wherein the processor determines whether the recognized sound or the recognized impulse is greater than a reference value, and calculates a location of the external input if the recognized sound or the recognized impulse is greater than the reference value.

7. The mobile device of claim 6, wherein the processor calculates the location of the external input if the recognized sound is greater than a first reference value and the recognized impulse is greater than a second reference value.

8. The mobile device of claim 1, wherein the processor processes at least one of a location tracing of another mobile device, a pattern unlock, a releasing of a locked state of the mobile device, a call reception, a call rejection, a browser gesture, a game control, an application control, an instruction defined by a user, and a distance measurement by determining a location of the external input among the multiple regions.

9. The mobile device of claim 1, wherein the sensor comprises at least one of a gyroscope sensor, an acceleration sensor, terrestrial magnetism sensor, and a direction sensor.

10. A method that uses a processor to recognize an external input, comprising:
recognizing a sound generated from an external input;
recognizing an impulse generated from the external input;
determining, using the processor, a location of the external input around a mobile device based on the recognized sound and the impulse; and
executing an instruction corresponding to the location of the external input.

11. The method of claim 10, further comprising:
calculating a distance difference between a first distance from the external input to a first microphone and a second distance from the external input to a second microphone based on the recognized sound.

12. The method of claim 11, further comprising:
obtaining a hyperbola trace based on the distance difference; and
calculating candidates of a location of the external input.

13. The method of claim 12, further comprising: calculating a direction of the external input based on the recognized impulse.

14. The method of claim 13, further comprising: calculating the location of the external input among the candidates using the direction of the external input.

15. The method of claim 10, further comprising: determining whether the recognized sound or the recognized impulse is greater than a reference value, and calculating the location of the external input if the recognized sound or the recognized impulse is greater than the reference value.

16. The method of claim 15, further comprising: calculating the location of the external input if the recognized sound is greater than a first reference value and the recognized impulse is greater than a second reference value.

17. The method of claim 10, further comprising:
processing at least one of a location tracing of another mobile device, a pattern unlock, a releasing of a locked state of the mobile device, a call reception, a call rejection, a browser gesture, a game control, an application control, an instruction defined by a user, and a distance measurement by determining the location of the external input among multiple regions around the mobile device.

18. The method of claim 10, wherein the sound is recognized by a plurality of microphones, and the impulse is recognized by at least one of a gyroscope sensor, an acceleration sensor, terrestrial magnetism sensor, and a direction sensor.

19. A mobile device, comprising:
a plurality of microphones to recognize a sound generated from an external input;
a sensor to recognize an impulse generated from the external input;
a distance calculation unit to calculate a time difference between a first receiving time from the external input to a first microphone and a second receiving time from the external input to a second microphone based on the recognized sound;
a direction calculation unit to calculate a direction of the external input based on the recognized impulse; and
a processor to determine a location of the external input based on the time difference and the direction, and to execute an instruction corresponding to the location of the external input.

20. The mobile device of claim 19, the distance calculation unit calculates a distance difference by multiplying the time difference and a velocity of the sound, and the processor calculates the location of the external input based on the distance difference and the direction.
